(19) United States
(12) Patent Application Publication
(10) Pub. No.: US 2023/0205949 A1
(43) Pub. Date: Jun. 29, 2023

(54) FULL CHIP POWER ESTIMATION USING MACHINE LEARNING

(71) Applicant: Advanced Micro Devices, Inc., Santa Clara, CA (US)

(72) Inventors: Peng Zhang, Shanghai (CN); Yuee Wu, Shanghai (CN); He Guan, Shanghai (CN); Xiaoxi Sun, Shanghai (CN); Yi Hao, Shanghai (CN)

(21) Appl. No.: 17/561,820

(22) Filed: Dec. 24, 2021

(51) Int. Cl. G06F 30/27; G06F 119/06

(52) U.S. Cl. CPC G06F 30/27; G06F 2119/06

(57) ABSTRACT

A system and method for efficient power analysis of an integrated circuit are described. In various implementations, a memory of a computing system stores combinatorial logic gate-level data describing functionality of a pre-silicon, gate-level representation of the integrated circuit being designed. The circuitry of the processor accesses this data, and also divides the integrated circuit into portions based on functionality. The circuitry of the processor generates first power estimation values over time for a selected first portion by executing a power estimation tool on the first portion. Afterward, the circuitry of the processor trains a data model, such as a neural network, using the generated first power estimation values. The circuitry of the processor then generates second power estimation values over time for one or more other portions by executing the data model on these portions.

### BACKGROUND

### Description of the Relevant Art

The power consumption of modern integrated circuits has become an increasing design issue with each generation of semiconductor chips. As power consumption increases, more costly cooling systems are utilized to remove excess heat and prevent failure of the integrated circuit. Examples of the costly cooling systems are larger fans, larger heat sinks and systems to control ambient temperature. Managing power consumption is not only an issue for portable computers and mobile communication devices, but also for high-performance superscalar microprocessors used in desktop and server systems.

One manner to manage power consumption, is to perform a power analysis of a pre-silicon, gate-level representation of the integrated circuit. Therefore, an estimation of the expected power consumption is found. Using this estimation, the effectiveness of on-die techniques is measured relatively early in the design process, and it is possible to change or adjust the techniques at such a time the estimated power consumption exceeds a target. Accordingly, power management begins prior to semiconductor fabrication of the integrated circuit. Examples of the integrated circuit are a central processing unit (CPU), a graphics processing unit (GPU), an accelerated processing unit (APU) that includes both a CPU and a GPU, one of a variety of types of an application specific integrated circuit (ASIC), a system on a chip (SoC), and so forth.

The integrated circuit typically includes a relatively large number of functional blocks and a large number of circuit nodes within the functional blocks. Therefore, the power analysis consumes an appreciable amount of time. For example, executing a power analysis tool on the pre-silicon, gate level representation of the integrated circuit can last weeks and even months. If the number of simulation iterations is reduced to shorten the power analysis, then accuracy of the estimated power consumption is also reduced.

In view of the above, efficient methods and mechanisms for efficient power analysis of an integrated circuit are desired.

### BRIEF DESCRIPTION OF THE DRAWINGS

FIG. 1 is a generalized diagram of a power estimation flow.

FIG. 2 is a generalized diagram of power signal waveforms.

FIG. 3 is a generalized diagram of a method for efficient power analysis of an integrated circuit.

FIG. 4 is a generalized diagram of a design flow for efficient power analysis of an integrated circuit.

FIG. 5 is a generalized diagram of a computing system for efficient power analysis of an integrated circuit.

FIG. 6 is a generalized diagram of a method for efficient power analysis of an integrated circuit.

FIG. 7 is a generalized diagram of a system stack for efficient power analysis of an integrated circuit.

FIG. 8 is a generalized diagram of a neural network model for efficient power analysis of an integrated circuit.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Systems and methods for efficient power analysis of an integrated circuit are disclosed. In implementations, a computing system includes a processor and a memory. The memory stores combinatorial logic gate-level data describing functionality of a pre-silicon, gate-level representation of the integrated circuit. For example, this data is output data of a synthesis tool executed on a register-transfer level (RTL) description of the hardware functionality of one or more functional blocks of the integrated circuit presented in a high-level programming language. It is possible that this data also includes circuit parasitic information provided by a parasitic extraction tool that calculates resistive, capacitive, and inductive parasitic effects in both the designed devices (transistors) and the wire interconnects of the signal routes.

In implementations, the memory also stores a data model that provides an estimate of power consumption over time (e.g., dynamic power) of a circuit. In some implementations, the data model is a neural network model. Examples of the neural network model are one of multiple types of convolutional neural networks and recurrent neural networks. In other implementations, the data model is a machine learning technique used to solve regression and classification problems. An example is a random forest (or random decision forest) machine learning algorithm that is constructed from multiple decision tree algorithms.

In implementations, the circuitry of the processor accesses the combinatorial logic gate-level data and divides the integrated circuit into multiple portions. In some designs, the circuitry divides the integrated circuit into portions based on functionality. Examples of the integrated circuit being designed are a central processing unit (CPU), a graphics processing unit (GPU), an accelerated processing unit (APU) that includes both a CPU and a GPU, one of a variety of types of an application specific integrated circuit (ASIC), a system on a chip (SoC), and so forth. Examples of the portions are a processor core of a CPU, a compute unit of a GPU, an interface unit, a cache controller, a tag or data array of a cache, and so forth. In some implementations, the circuitry of the processor groups the multiple portions into categories based also on functionality. For example, the circuitry of the processor groups 64 compute units of a GPU into a first category, and groups a data array and access logic of a data store of the GPU into a second category, and so forth. It is noted that the granularity of dividing the integrated circuit that is being designed is finer or broader in other implementations.

The circuitry of the processor selects a first category of multiple categories of the integrated circuit. The circuitry of the processor selects a first portion of multiple portions within the selected first category. The circuitry of the processor generates first power estimation values over time for the selected first portion by executing a power estimation tool on the first portion. Afterward, the circuitry of the processor trains the data model using the generated first power estimation values over time for the selected first portion. Therefore, the circuity of the processor uses the first power estimation values over time to validate results generated by the data model while the data model is being trained. The circuitry of the processor continues this training process until convergence is achieved. Once convergence is achieved, the data model is considered to be trained. The circuitry of the processor executes the trained data model, rather than the power estimation tool, on the remaining one or more portions of the first category. While executing the trained data model, the circuitry of the processor generates second power estimation values over time for the remaining one or more portions of the first category. Therefore, the circuitry of the processor generates power estimation values over time for multiple portions of the integrated circuit using the trained data model, which is trained by power estimation values over time of other portions generated by the power estimation tool. Accordingly, accuracy of the power analysis is maintained while significantly reducing the time to perform the power analysis.

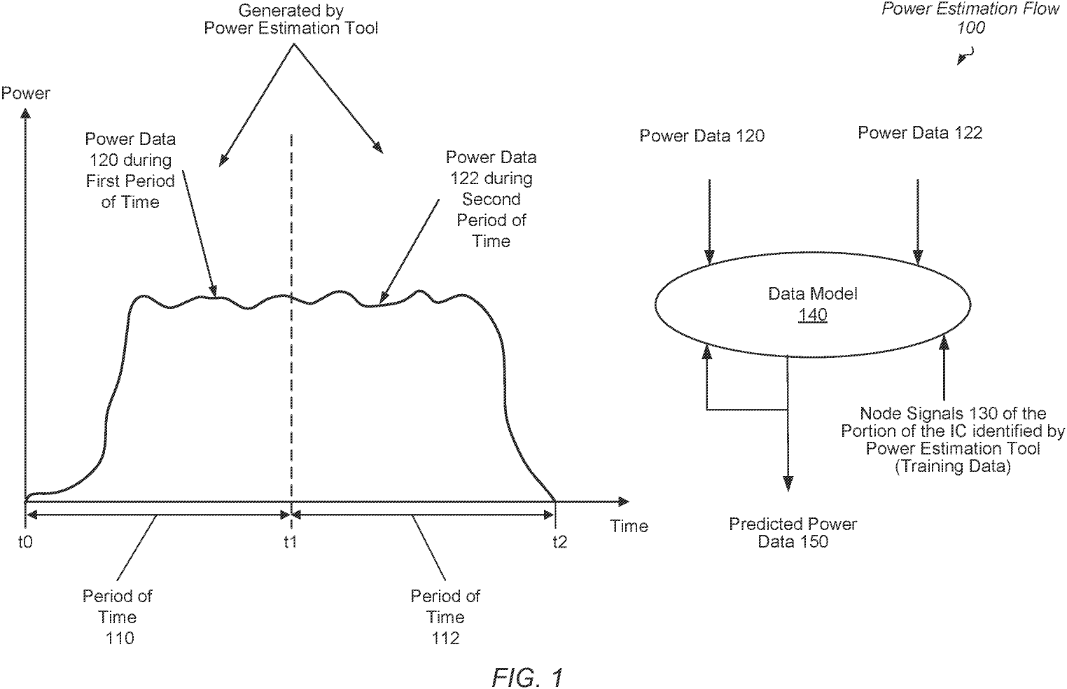

Turning now to FIG. 1, a generalized diagram is shown of a power estimation flow 100 of an integrated circuit. In various implementations, an integrated circuit is being designed, and this integrated circuit is divided into portions. In some designs, the integrated circuit is divided into portions based on functionality. The circuitry of a processor (not shown) accesses combinatorial logic gate-level data (not shown) describing functionality of a pre-silicon, gate-level representation of the integrated circuit. The processor also accesses circuit parasitic information provided by a parasitic extraction tool. The processor selects one of the multiple portions. The processor executes a power estimation tool on the selected portion, rather than execute the power estimation tool on the entire integrated circuit. Executing the power estimation tool generates the power signal waveform shown on the left side of the diagram. The x-axis of the signal waveform diagram indicates duration of time, and the y-axis indicates a measurement of power consumption of the selected portion.

The entire duration of time for performing power estimation on the selected portion is indicated by the range of time from the point in time t0 (or time t0) to the point in time t2 (or t2). This entire duration of time is divided into periods of time identified as period 110 and period 112. The time t1 indicates a point in time that divides the entire period of time (t2-t0) into two portions. In some implementations, the time t1 occurs at the midpoint such that the period 110 is equal to the period 112. However, it is possible and contemplated that the time t1 is selected to occur at other time values between time t0 and time t2. The dynamic power estimation data (or power data) of the selected portion of the integrated circuit generated during period 110 is shown as power data 120. Similarly, power data 122 shows the dynamic power data of the selected portion of the integrated circuit generated during period 112.

After the processor completes executing the power estimation tool during both periods 110 and 112 on the portion of the integrated circuit as described above, the processor sends the power data 120 to the data model 140. The processor also sends, or otherwise makes available, node signals 130 of the portion of the integrated circuit to be used as training data for the data model 140. The data model 140 uses the power data 120 over the period 110 and the node signals 130 to determine relationships between the received power data 120 and the node signals 130. These relationships within the data model 140 are used to generate the predicted power data 150 over the period 112, which is compared to the power data 122 that was generated earlier by the power estimation tool over the period 112. When the predicted power data 150 and the power data 122 closely match (within a predetermined error threshold), the data model 140 is deemed to have converged. In some implementations, the power estimation tool identifies the node signals 130. In an implementation, the power estimation tool calculates an amount of switching node capacitance of nodes, sorts them, and selects a subset of the nodes with an amount of switching node capacitance equal to or greater than a capacitance threshold. Node signals are chosen that have a high correlation with the node capacitance switching behavior such as clock enable signals on the last stage of a clock distribution system. There are signals whose assertion indicates an appreciable amount of switched capacitance aside from the clock enable signals. Some examples are bus driver enable signals, signals that indicate mismatches in content-addressable memories (CAM), and output signals of CAM word-line (WL) drivers. In other implementations, the data model 140 receives each node of the portion of the integrated circuit, which is still significantly less than all nodes of the entire integrated circuit.

The power consumption of integrated circuits, such as modern complementary metal oxide semiconductor (CMOS) chips, is proportional to the expression αfCV². The symbol α is the switching factor, or the probability a node will charge up or discharge during a clock cycle. The symbol f is the operational frequency of the chip. The symbol C is the equivalent capacitance, or the switching capacitance, to be charged or discharged in a clock cycle. The symbol V is the operational voltage of the chip. Real-time power estimation is achieved when measuring the switching capacitance on a circuit (e.g., during a particular clock cycle). A node capacitance, CAC, includes the switched or alternating current (AC) capacitance.

In some implementations, the data model 140 is a neural network model. Examples of the neural network model are one of multiple types of convolutional neural networks and recurrent neural networks. In other implementations, the data model 140 is a machine learning technique used to solve regression and classification problems. An example is a random forest (or random decision forest) machine learning algorithm that is constructed from multiple decision tree algorithms. The manner in which relationships are determined between the power data 120 and the node signals 130 is based on the selected implementation of the data model 140. While the processor executes the data model 140, the processor trains the data model 140 using the received power data 120 and the node signals 130. As described earlier, the data model 140 determines relationships over time between the received power data 120 and the node signals 130.

The data model 140 generates the predicted power data 150. Afterward, one or more of the data model 140 and other logic (not shown) compares the values of the power data 122 to the values of the predicted power data 150. As described earlier, the power data 122 is the dynamic power data of the selected portion of the integrated circuit generated by the power estimation tool during period 112. If an error of the comparison between the predicted power data 150 over the period 112 and the power data 122 over the period 112 is less than or equal to a threshold, then the data model 140 is deemed to have converged. Consequently, the data model 140 is ready to be used to generate power estimation data over time for other portions of the integrated circuit.

Otherwise, if the error of the comparison between the predicted power data 150 over the period 112 and the power data 122 over the period 112 is greater than the error threshold, then the data model 140 continues attempting to determine relationships between the received power data 120 over the period 110 and the node signals 130 that generate predicted power data 150 over the period 112 that closely matches (within a predetermined error threshold) the power data 122 over the period 112. As described earlier, the power data 120 is the dynamic power data of the selected portion of the integrated circuit generated by the power estimation tool during period 110, and the power data 122 is the dynamic power data of the selected portion of the integrated circuit generated by the power estimation tool during period 112. While the processor executes the data model 140, the processor continues training the data model 140 using the received power data 120 and the node signals 130 until a particular condition is satisfied. As described earlier, the received power data 120 is the dynamic power estimation data (or power data) of the selected portion of the integrated circuit generated during period 110 by the power estimation tool. Examples of the condition to satisfy are convergence is achieved, a failure condition is detected (e.g., convergence has not been achieved after a period of time, number of iterations, or otherwise), or some other condition is detected.

Examples of the integrated circuit being designed are a central processing unit (CPU), a graphics processing unit (GPU), an accelerated processing unit (APU) that includes both a CPU and a GPU, one of a variety of types of an application specific integrated circuit (ASIC), a system on a chip (SoC), and so forth. Examples of the portions of the integrated circuit are a processor core of a CPU, a compute unit of a GPU, an interface unit, a cache controller, a tag or data array of a cache, and so forth. In some implementations, the circuitry of the processor combines the multiple portions into categories based also on functionality. For example, the circuitry of the processor combines 64 compute units of a GPU into a first category, and groups a data array and access logic of a data store of the GPU into a second category, and so forth.

It is noted that the granularity of dividing the integrated circuit being designed is finer or broader in other implementations. In each case, the circuitry of the processor generates power estimation values over time for multiple portions using the data model 140 trained by dynamic power estimation values of other portions generated by the power estimation tool. Therefore, accuracy of the pre-silicon, gate-level power analysis is maintained while significantly reducing the time to perform the power analysis.

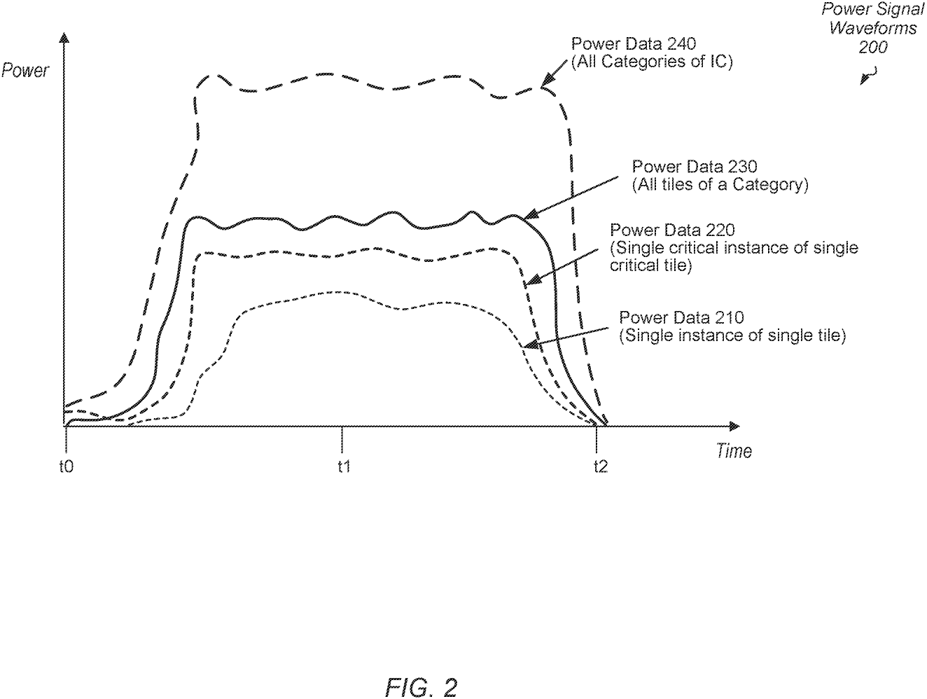

Referring to FIG. 2, a generalized diagram is shown of power signal waveforms 200 of an integrated circuit. As shown, the power signal waveforms 200 includes four waveforms corresponding to a same integrated circuit that is being designed. The x-axis of the signal waveform diagram indicates duration of time, and the y-axis indicates a measurement of power consumption of particular portions or an entirety of the integrated circuit. The entire duration of time for performing power estimation is indicated by the range of time from the time t0 to the time t2. Each of the waveforms 210-230 show power data that is associated with a particular one or more portions of the integrated circuit, whereas, waveform 240 shows power data that is associated with the entire integrated circuit. As described earlier, in various implementations, the integrated circuit that is being designed is divided into portions based on functionality.

In an implementation, the integrated circuit is initially divided into categories which are then divided into tiles. The tiles are further divided into instances. In one example, a CPU that is being designed is divided into a first category that includes a processing unit, a second category that includes a cache, and a third category that includes an interface unit. The first category (processing unit) is divided into eight tiles with each tile being a processor core. Each tile is further divided into three instances with a first instance being the functional blocks of a front-end of an execution pipeline, a second instance being the functional blocks of a midportion of the execution pipeline, and a third instance being the functional blocks of a back-end of the execution pipeline. The second category (cache) is divided into a tag array tile, a data array tile, and a cache controller tile. The arrays include instances such as rows or columns of the arrays. The cache controller includes instances such as data storage queues, an arbitration and issue unit, and so forth. In implementations, a variety of other examples of categories, tiles and instances are possible and contemplated.

Similar to the power data 120 and 122 (of FIG. 1), a power estimation tool executed by a processor generates the power data 210 of a single instance of a single tile. As described earlier, the processor (not shown) accesses combinatorial logic gate-level data (not shown) describing functionality of a pre-silicon, gate-level representation of the single instance of the single tile. The processor also accesses circuit parasitic information provided by a parasitic extraction tool. Using this data, the processor executes the power estimation tool. A variety of examples of the power estimation tool used in an electronic design automation (EDA) tool suite are possible and contemplated. Executing the power estimation tool generates the power signal waveform with power data 210.

In a similar manner, the power signal waveform with power data 220 is generated. However, the processor or designer selects a critical instance of a critical tile of the integrated circuit to use to generate the power data 220. A variety of factors are used to define which instance and which tile are considered critical. Examples of the factors are an amount of switching capacitance and functionality. When the processor executes the power estimation tool on each of the tiles in a particular category, the processor generates the waveform with power data 230. As shown, although lower in power consumption, the power data 220 resembles the values and shape of power data 230. Therefore, the critical instance of the critical tile provides a good representation of the power consumption behavior of the category. When the processor executes the power estimation tool on each of the categories, the processor generates the waveform with power data 240.

As described earlier, the integrated circuit that is being designed typically includes a relatively large number of functional blocks and a large number of circuit nodes within the functional blocks. Therefore, the power analysis provided by executing the power estimation tool consumes an appreciable amount of time. However, selecting particular instances of particular tiles, such as the critical instance of the critical tile used to generate power data 220, allows the power analysis to be split. In various implementations, a first part of the power analysis uses execution of the power estimation tool on a critical subset of the integrated circuit. In implementations, the resulting power data is used to train a data model such as a neural network. In implementations, the second part of the power analysis uses execution of the data model on the remainder of the integrated circuit to generate an estimate of the power consumption over time (e.g., dynamic power consumption) of the remainder of the integrated circuit.

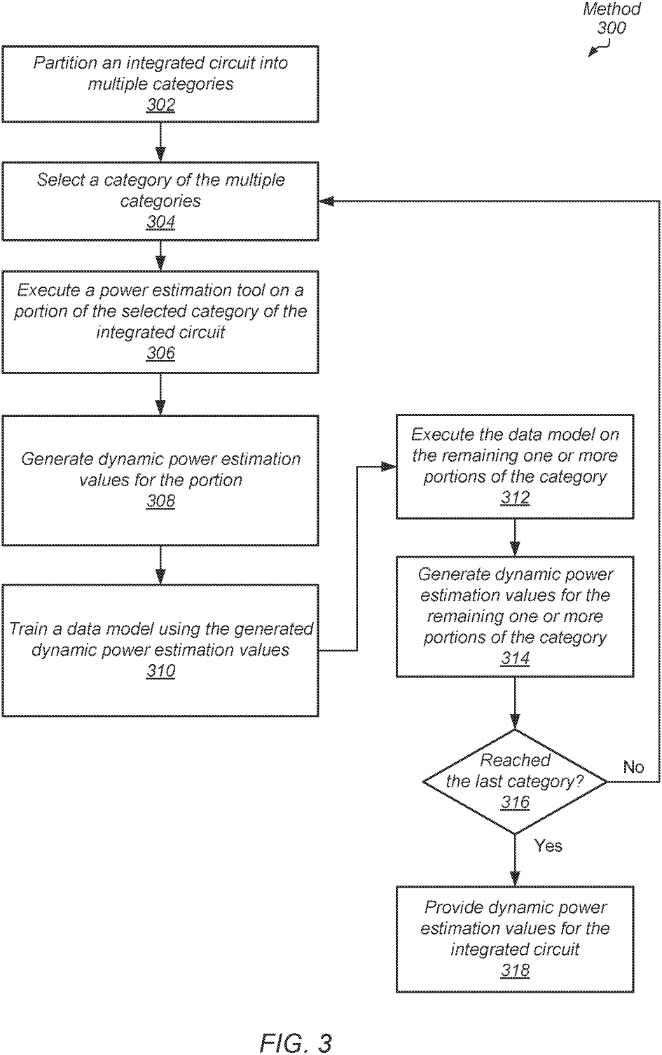

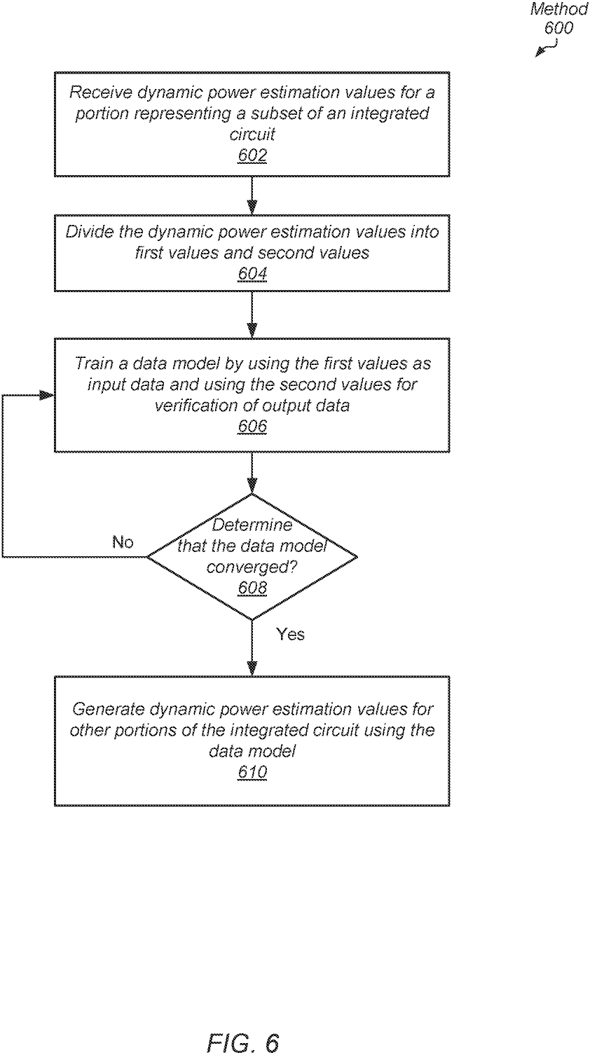

Turning now to FIG. 3, a generalized diagram is shown of a method 300 for efficient power analysis of an integrated circuit. For purposes of discussion, the steps in this implementation (as well as in FIGS. 6 and 9) are shown in sequential order. However, in other implementations some steps occur in a different order than shown, some steps are performed concurrently, some steps are combined with other steps, and some steps are absent.

In an implementation, a portion of an integrated circuit is identified for power analysis. In various embodiments, the portion identified is less than an entire design circuit (i.e., the identified portion is less than an entire SOC, processor, or otherwise. In some implementations, the integrated circuit is partitioned according to various categories (block 302). In implementations, the categories are further divided into tiles and instances as described earlier regarding the power signal waveforms 200 (of FIG. 2). In other designs, other approaches are used to partitioning the integrated circuit or otherwise identify selected portions for analysis. In some implementations, a processor being used to perform power analysis on the integrated circuit selects a category of the multiple categories of the integrated circuit (block 304). For example, identifiers of the categories are used in a script or other file to indicate which category is having power analysis done.

In implementations, the processor executes a power estimation tool on a pre-silicon, gate-level model of a portion of the selected category of the integrated circuit (block 306). For example, the processor executes the power estimation tool of an EDA tool suite on a particular instance of a particular tile of the selected category. To do so, the processor accesses combinatorial logic gate-level data describing functionality of a pre-silicon, gate-level representation of the particular instance of the particular tile. The processor also accesses circuit parasitic information provided by a parasitic extraction tool. Using this data, the processor executes the power estimation tool to generate dynamic power estimation values for the particular portion of the integrated circuit, rather than the entire integrated circuit (block 308).

The processor accesses a data model such as a neural network model. In implementations, the processor trains the data model using at least the generated dynamic power estimation values (block 310). The data model 140 generates predicted power data for the particular portion of the category that is compared, by the data model or other logic, to the values of the power data generated earlier by the power estimation tool for the particular portion of the category. In some implementations, the neural network model uses a cost function that measures how well the generated output values matched predicted output values. The cost function also measures a value of the weights used by the nodes (or neurons) in the one or more hidden layers of the neural network model.

If the measure of error is greater than an error threshold, then the data model continues training by reiterating the processing of the power data using weights and activation functions of the nodes. If the measure of error is less than or equal to the error threshold, then the data model converges. Consequently, the data model is ready to be used to generate dynamic power estimation values for other portions of the integrated circuit.

When the data model converges, the processor executes the data model on the remaining one or more portions of the category (block 312). The processor generates dynamic power estimation values for the remaining one or more portions of the category (block 314). If a last category of the multiple categories has not been reached (“no” branch of the conditional block 316), then control flow of method 300 returns to block 304 where the processor selects another category of the multiple categories. If the last category of the multiple categories has been reached (“yes” branch of the conditional block 316), then the processor provides dynamic power estimation values for the integrated circuit (block 318).

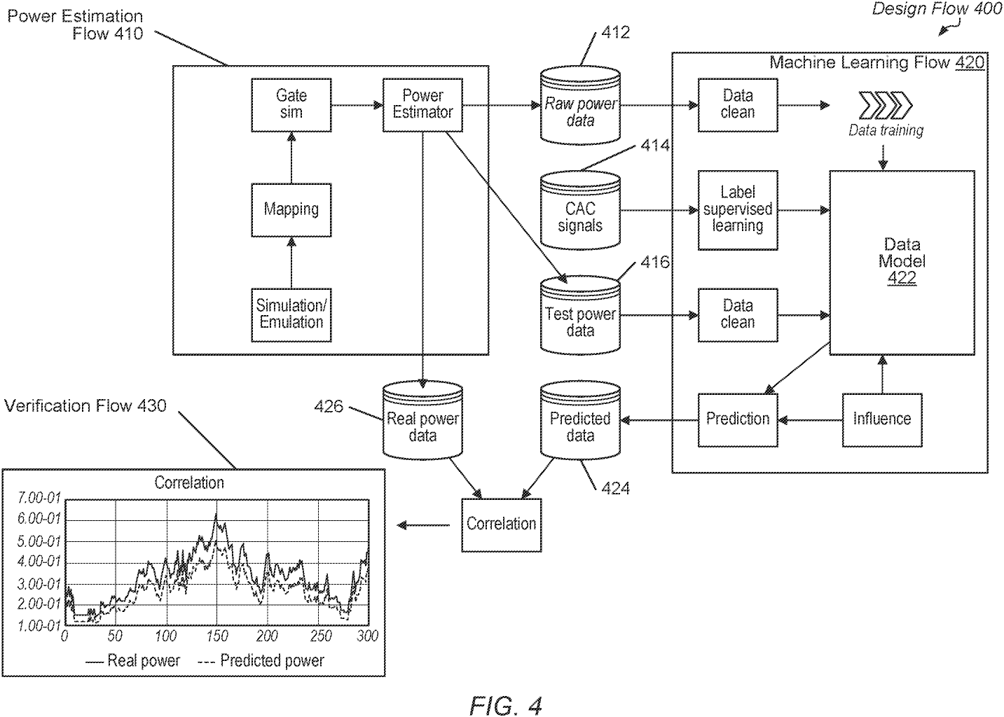

Referring to FIG. 4, a generalized diagram is shown of a design flow 400 for efficient power analysis of an integrated circuit. The design flow 400 includes a power estimation flow 410, a machine learning flow 420, and in some implementations a verification flow 430 that uses post-silicon data. The power estimation flow 410 accesses combinatorial logic gate-level data describing functionality of a pre-silicon, gate-level representation of a particular portion being analyzed (e.g., an instance of a particular tile). The designer had already identified partitions of the integrated circuit, as described earlier, according to various categories, tiles, and instances regarding the power signal waveforms 200 (of FIG. 2).

An EDA tool suite includes a synthesis tool and parasitic extraction tool to provide the simulation and emulation data that is mapped to the gates and devices (transistors) of the particular portion of the integrated circuit. The power estimation flow 410 generates power estimation values over time (or dynamic power estimation values), such as the raw power data 412 and the test power data 416, for the particular portion (e.g., instance of a tile). In an implementation, the raw power data 412 and the test power data 416 correspond to the power data 120 and 122 (of FIG. 1). In addition to the above, additional data such as CAC signal data 414 is also provided as input to the model.

In an implementation, the machine learning flow 420 includes blocks indicated as “data clean” that reformat data before being received by a next stage of processing. Each of the blocks “Label supervised learning” and “Influence” allow one or more of the designer, the power estimator, and another control unit (not shown) to rank the CAC signals 414 in terms of impact on the predicted dynamic power estimation values such as predicted data 424. In some implementations, the data model 422 is a neural network model. Examples of the neural network model are one of multiple types of convolutional neural networks and recurrent neural networks. In other implementations, the data model 422 is a machine learning technique used to solve regression and classification problems. An example is a random forest (or random decision forest) machine learning algorithm that is constructed from multiple decision tree algorithms.

The data model 422 is trained using the raw power data 412 as input data along with the CAC signals 414 while convergence is based on the test power data 416. When the data model 422 converges, the designer is able to use the data model 422 to generate dynamic power estimation values for the remainder of the integrated circuit using the CAC signals of the remaining instances and tiles of the integrated circuit. The designer performs these steps for each of the multiple categories of the integrated circuit to determine the predicted dynamic power estimation of the entire integrated circuit. Using the trained data model 422 allows the designer to significantly reduce the time to obtain the predicted dynamic power estimation of the entire integrated circuit without sacrificing accuracy.

In some implementations, the integrated circuit that is being designed is a proliferation of an initial flagship design. In other words, the integrated circuit had already been designed, but a newer version is being produced with minor adjustments. In such cases, the power estimation flow 410 provides real power data 426 using post-silicon information of the previous flagship design. The verification flow 430 compares the predicted data 424 provided by the data model 422 with the real power data 426. The results are used to further train the data model 422.

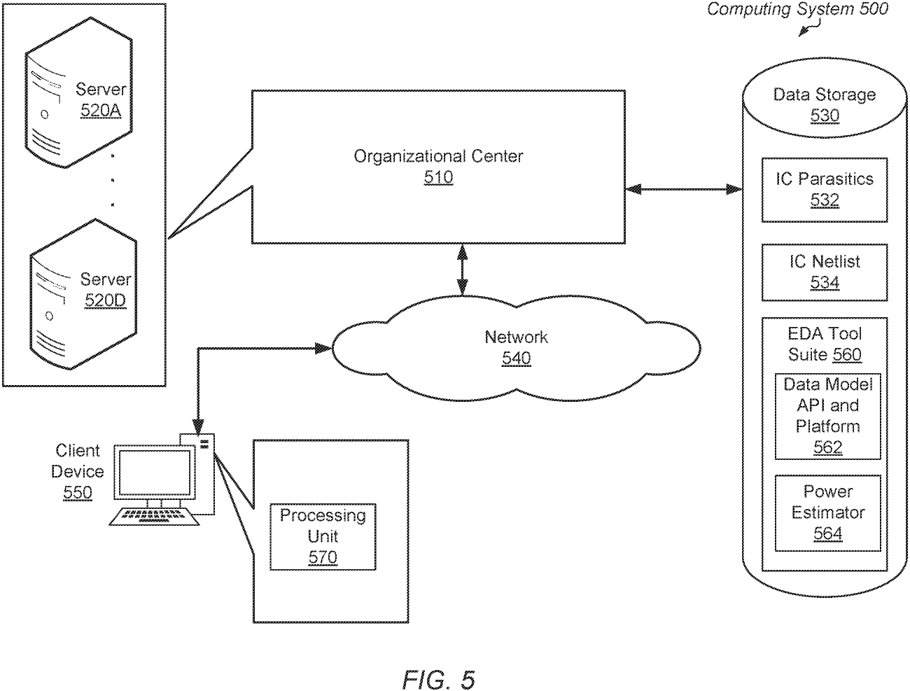

Turning now to FIG. 5, a generalized diagram is shown of a computing system 500 for efficient power analysis of an integrated circuit. In the illustrated implementation, the computing system 500 includes the client computing device 550, the servers 520A-520D that include hardware for executing software and supporting the organizational center 510, a network 540, and the data storage 530 that includes one or more data stores supported and used by the organizational center 510. Although a single client computing device 550 is shown, any number of client computing devices utilize the organizational center 510 through the network 540. The client computing device 550, which is also referred to as client device 550, includes hardware, such as circuitry of a processor, to execute instructions of a copy of software tools stored on data storage 530. Similarly, a user can use client device 550 to initiate batch jobs or execute instructions of a copy of tools stored on data storage 530 on any one of the servers 520A-520D. Examples of the tools are a variety of tools of the electronic design automated (EDA) tool suite 560 such as at least a data model application programming interface (API) and platform 562 and a power estimation tool (power estimator) 564.

In implementations, the client device 550 includes a desktop computer or a mobile computing device such as a laptop, a tablet computer, and so forth. The client device 550 includes hardware circuitry such as a processing unit 570 for processing instructions of computer programs. In some implementations, the processing unit 570 includes one or more homogeneous cores of a processor. In other implementations, the processing unit includes heterogeneous cores such as a parallel processing architected core and a general-purpose core as used in central processing units (CPUs). The parallel architected core is be a graphics processing unit (GPU), a digital signal processing unit (DSP) or other.

In implementations, the client device 550 includes a network interface (not shown) supporting one or more communication protocols for data and message transfers through the network 540. The network 540 includes multiple switches, routers, cables, wireless transmitters and the Internet for transferring messages and data. Accordingly, the network interfaces of the organizational center 510 and the client device 550 support at least the Hypertext Transfer Protocol (HTTP) for communication across the World Wide Web. In addition to communicating with the client device 550 through the network 540, the organizational center 510 also communicates with the data storage 530 for storing and retrieving data.

In various implementations, the organizational center 510 is an infrastructure for a vendor producing one or more hardware products. The organizational center 510 includes an intranet network providing a private network. An intranet portal is used to provide access to resources with a user-friendly interface such as graphical user interfaces (GUIs) and dashboards. The information and services made available by the organizational center 510 is unavailable to the general public through direct access. Through user authentication, the staff members are able to access resources through the organizational center 510 to communicate with other staff members, collaborate on projects and monitor product development, update products, documents and tools stored in a centralized repository and so forth.

The servers 520A-520D used for supporting the organizational center 510 and resources accessed through the organizational center 510 include a variety of server types such as database servers, computing servers, application servers, file servers, mail servers and so on. In various implementations, the servers 520A-520D and the client device 550 operate with a client-server architectural model. One or more of the servers 520A-520D and the client device 550 has a copy of the power estimator 564, the integrated circuit (IC) netlist 534, and the IC parasitics (node circuit parasitic information) 532, and the data model API and platform 562. The designer uses one or more of the servers 520A-520D and the client device 550 to execute the power estimator 564 on a pre-silicon, gate-level model of a portion of the integrated circuit that is being designed. The designer had already partitioned the integrated circuit that is being designed into multiple categories, tiles, and instances as described earlier regarding the power signal waveforms 200 (of FIG. 2).

The processor of one of the servers 520A-520D and the client device 550 accesses combinatorial logic gate-level data describing functionality of a pre-silicon, gate-level representation of the particular instance of the particular tile. For example, the EDA tool suite 560 includes a synthesis tool (not shown). The processor also accesses the IC parasitics 532 provided by a parasitic extraction tool (not shown) of the EDA tool suite 560. Using this data, the processor executes the power estimator 564 to generate power estimation values over time for the particular portion (e.g., instance of a tile) of the selected category, rather than the entire category or the entire integrated circuit.

The designer uses a copy of the data model API and platform 562 to specify multiple characterizing parameters of a data model. An example of the data model is a random forest (or random decision forest) machine learning algorithm that is constructed from multiple decision tree algorithms. Another example of the data model is a neural network model. When the data model is a neural network model, examples of the parameters are a number of input variables for the input layer of the neural network, an initial set of weights, a number of hidden layers, a number of nodes or neurons for each of the hidden layers, an indication of an activation function to use in each of the hidden layers, and so on. The processor of one of the servers 520A-520D and the client device 550 trains the data model using the specified parameters from the designer and at least the generated power estimation values over time provided by the power estimator 564.

In implementations, during training of the data model, the data model generates predicted power data for the particular portion (e.g., instance of a tile) of the integrated circuit. When the data model converges, the designer uses one of the servers 520A-520D and the client device 550 to execute the trained data model on the remainder of the category of the integrated circuit. The designer performs these steps of training the data model and using the trained data model for each of the multiple categories of the integrated circuit to determine the predicted dynamic power estimation of the entire integrated circuit. Using the trained data model allows the designer to significantly reduce the time to obtain the predicted dynamic power estimation of the entire integrated circuit without sacrificing accuracy.

Turning now to FIG. 6, a generalized diagram is shown of a method 600 for efficient power analysis of an integrated circuit according to implementations. In some designs, designers use categories, tiles and instances as described earlier regarding the power signal waveforms 200 (of FIG. 2). In other designs, the designers use other granularities for partitioning the integrated circuit. When instances and tiles are used, a processor receives dynamic power estimation values of a single instance of a tile of a pre-silicon, gate-level model of the integrated circuit (block 602). In one implementation, the processor executed a power estimation tool of an EDA tool suite and generated the power estimation values over time. In another implementation, another processor executed the power estimation tool, and the results are stored in a known memory location, which is accessed by the processor. In implementations, the processor divides the power estimation values over time into a first partition and a second partition (block 604). In various implementations, this division is similar to the division that created periods 110 and 112 of FIG. 1).

In implementations, the processor trains a data model by using the power estimation values of the first partition as input data and by using the power estimation values of the second partition for verification of output data (block 606). The data model determines relationships between the received power estimation values of the first partition and the node signals of the single instance. In implementations, the data model receives each node of the single instance. In other implementations, the data model receives a subset of the total number of nodes of the single instance where the subset is selected based on an amount of active node switching capacitance. In implementations, the data model is a neural network model. Examples of the neural network model are one of multiple types of convolutional neural networks and recurrent neural networks. In other implementations, the data model is a machine learning technique used to solve regression and classification problems. An example is a random forest (or random decision forest) machine learning algorithm that is constructed from multiple decision tree algorithms.

In implementations, while the processor trains the data model, the processor compares predicted power estimation values generated by the data model and the received power estimation values of the second partition. When a measured error between these values is less than or equal to an error threshold, the data model converges. If the processor does not determine that the data model converges (“no” branch of the conditional block 608), then control flow of method 600 returns to block 606 where the data model continues training by reiterating the processing of received data. If the processor determines that the data model converges (“yes” branch of the conditional block 608), then the processor generates dynamic power estimation values for the remaining instances of the tile by executing the data model on the pre-silicon, gate-level model of the remaining instances of the tile (block 610).

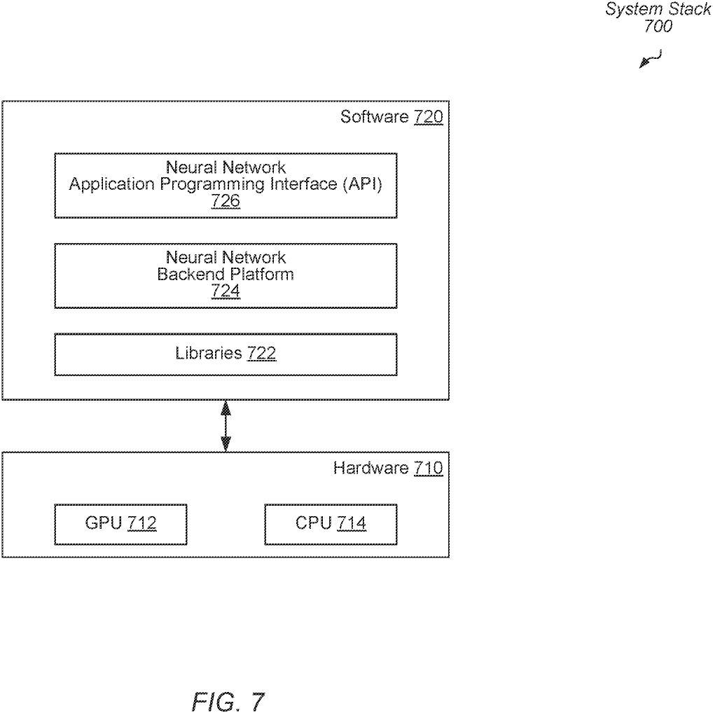

Referring to FIG. 7, a generalized diagram is shown of a system stack 700 for efficient power analysis of an integrated circuit. The system stack 700 includes software 720 executing on the hardware 710. The hardware 710 includes one or more of a variety of processing units. As shown, hardware 710 uses a GPU 712 and a CPU 714. However, in other implementations, the hardware 710 includes other types of processing units in addition to or in place of the GPU 712 and the CPU 714. The software 720 includes libraries 722. One example of the libraries 722 are Basic Linear Algebra Subprograms (BLAS) that provide low-level routines for performing linear algebra operations such as dot products, matrix multiplication, scalar multiplication, and vector addition. The BLAS routines are typically optimized for higher performance on a particular hardware microarchitecture. Another example of the libraries 722 is Eigen, which is a high-level C++ library of template headers for linear algebra operations.

When the data model is a neural network model, the software 720 also includes the neural network application programming interface (API) 726 and the neural network backend platform 724. A designer uses the neural network API 726 to specify multiple characterizing parameters. Examples of these parameters are a number of input variables for the input layer of the neural network, an initial set of weights, a number of hidden layers, a number of nodes or neurons for each of the hidden layers, an indication of an activation function to use in each of the hidden layers, and so on. In an implementation, the designer sets the number of input variables to a number of node signals of an instance of a tile where the node signals have an active switching capacitance above a capacitance threshold. In another implementation, the designer sets the number of input variables to a total number of node signals of the instance, which is significantly less than the total number of node signals of the entire integrated circuit.

An example of the neural network API 726 is the Keras library that acts as an interface for the TensorFlow library. The neural network API 726 provides image and text data to simplify accessing and specifying neural network building blocks such as layers, objectives, activation functions, and optimizers. The TensorFlow library is an example of the neural network backend platform 724, which compiles or builds the neural network model based on inputs from the designer through the neural network API 726, and provides access to the libraires 722.

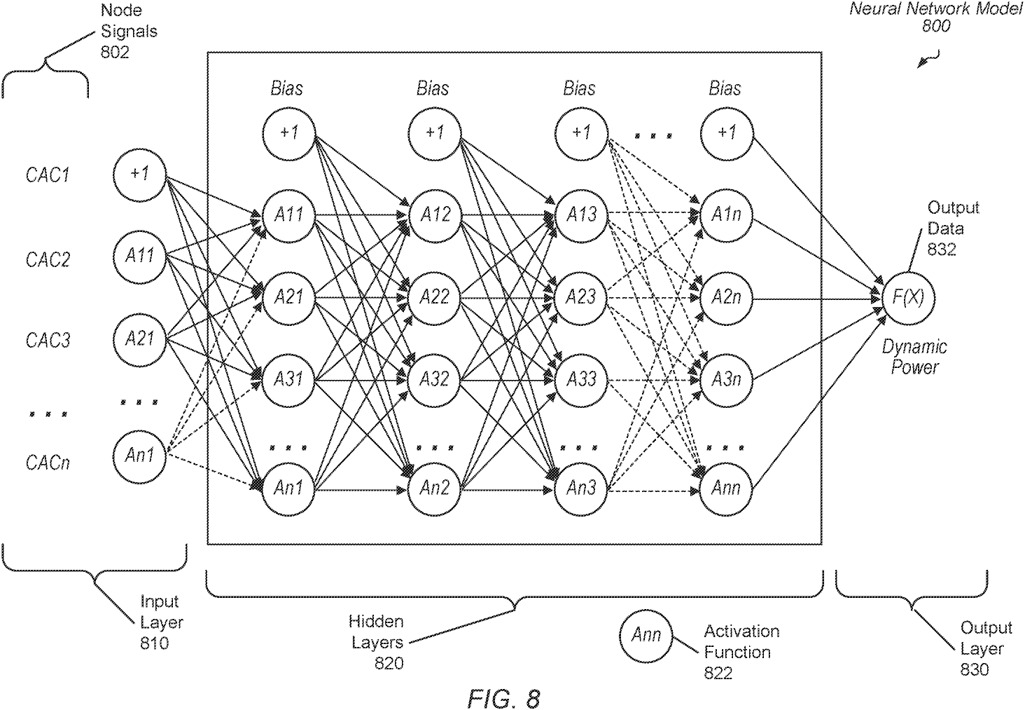

Referring to FIG. 8, a generalized diagram is shown of a neural network model 800 for efficient power analysis of an integrated circuit. When the data model is a neural network model, such as neural network model 800, the data model includes an input layer 810, one or more hidden layers 820, and an output layer 830. The input layer 810 includes the initial input variables for the neural network model 800, which is an input vector. Here, the node signals 802 provides the input vector. In an implementation, the node signals 802 includes each of the signals of an instance, a tile, or other portion of an integrated circuit being used to train the neural network model 800. In another implementation, the node signals 802 includes a subset of the total number of signals of the selected portion of the integrated circuit whose assertion indicates an appreciable amount of switched capacitance. These signals are indicated as node capacitance (CAC) signals. For example, the power estimation tool or other tool of the EDA tool suite identified signals with a switch capacitance above a capacitance threshold. Examples of such node signals are clock enable signals, bus driver enable signals, signals that indicate mismatches in content-addressable memories (CAM), and output signals of CAM word-line (WL) drivers.

In another implementation, the input layer 810 includes the input vector, such as the node signals 812, and a first layer of activation nodes (or neurons). Each node of this first layer receives a product of a weight (not shown) and one of the input variables of the input vector. For example, each of the node signals 812 is multiplied by a weight and the product is received by each node of this first layer. Each node of this first layer performs a sum of theses weighted values. Each of these nodes performs a unit step function, which determines whether the node will be activated. In other words, each of these nodes uses a predetermined activation function indicated as activation function 822.

An example of the activation function 822 is the rectified linear (ReLU) activation function, which is a piecewise linear function used to transform a weighted sum of the input variables into the activation of a corresponding node or output. When activated, the node (or neuron) generates a non-zero value, and when not activated, the node (or neuron) generates a zero value. The additional node with value 1 is called a “bias” node of the neural network model 800. In other implementations, this first layer is within the hidden layers 820.

The hidden layers 820 includes one or more additional layers of nodes. The output layer 832 generates the result, or output data 832, for input vector such as the node signals 812 and the set of weights being used by the layers in the input layer 810 and the hidden layers 820. The dynamic power estimation value of the selected portion of the integrated circuit is represented by the output data 832. As described earlier, the designer uses the neural network API 726 (of FIG. 7) to specify multiple characterizing parameters. Examples of these parameters are a number of input variables for the input layer 810 of the neural network model 800, an initial set of weights, a number of layers of the hidden layer 820, a number of nodes or neurons for each of the hidden layers, an indication of an activation function 822 to use in each of the hidden layers, a loss function to use to measure the effectiveness of the mapping between the input vector (node signals 810) and the output data 832, and so on. In some implementations, different layers use different activation functions.

The training process of the neural network model 800 is an iterative process that finds a set of weight values used for mapping the input vector, such as the node signals 812, received by the input layer 810 to the output data 832. The specified loss function evaluates the current set of weights. One or more of forward propagation and backward propagation used with or without gradient descent is used to minimize the cost function by inspecting changes in the bias, the previous activation function results, and the current set of weights.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. A processor comprising:
circuitry configured to:
divide first power estimation values corresponding to an integrated circuit into first values and second values, wherein the first values correspond to a first period of time and the second values correspond to a second period of time later than the first period of time; and
generate second power estimation values using a trained data model, wherein training the data model comprises:
using the first values as input values to the data model during the training; and
using the second values as verification values during the training.

2. The processor as recited in claim 1, wherein the circuitry is further configured to use capacitance related values corresponding to nodes of the integrated circuit to use as inputs to the data model.

3. The processor as recited in claim 1, wherein:
the first power estimation values correspond to a first portion of the integrated circuit; and
the second power estimation values are used for a second portion of the integrated circuit.

4. The processor as recited in claim 1, wherein the first power estimation values and the second power estimation values correspond to a pre-silicon model of the integrated circuit.

5. The processor as recited in claim 1, wherein during the training, the circuitry is configured to:
compare output values of the data model with the second values; and
determine the data model converges, in response to an error between the output values and the second values being less than a threshold.

6. The processor as recited in claim 1, wherein the data model comprises a neural network.

7. The processor as recited in claim 2, wherein the circuitry is further configured to divide the capacitance related values into first values that correspond to the first period of time and second values that correspond to the second period of time.

8. A method comprising:
dividing first power estimation values corresponding to an integrated circuit into first values and second values, wherein the first values correspond to a first period of time and the second values correspond to a second period of time later than the first period of time; and
generating second power estimation values using a trained data model, wherein training the data model comprises:
using the first values as input values to the data model during the training; and
using the second values as verification values during the training.

9. The method as recited in claim 8, further comprising using capacitance related values corresponding to nodes of the integrated circuit to use as inputs to the data model.

10. The method as recited in claim 8, wherein:
the first power estimation values correspond to a first portion of the integrated circuit; and
the second power estimation values are used for a second portion of the integrated circuit.

11. The method as recited in claim 8, wherein the first power estimation values and the second power estimation values correspond to a pre-silicon model of the integrated circuit.

12. The method as recited in claim 8, wherein during the training, the method comprises:
comparing output values of the data model with the second values; and
determining the data model converges, in response to an error between the output values and the second values being less than a threshold.

13. The method as recited in claim 8, wherein the data model comprises a neural network.

14. The method as recited in claim 9, further comprising dividing the capacitance related values into first values that correspond to the first period of time and second values that correspond to the second period of time.

15. A computing system comprising:
a memory configured to store:
data describing functionality of an integrated circuit;
a data model; and
first power estimation values; and
a processor comprising circuitry configured to:
divide first power estimation values corresponding to an integrated circuit into first values and second values, wherein the first values correspond to a first period of time and the second values correspond to a second period of time later than the first period of time; and
generate second power estimation values using a trained data model, wherein training the data model comprises:
using the first values as input values to the data model during the training; and
using the second values as verification values during the training.

16. The computing system as recited in claim 15, wherein the circuitry is further configured to use capacitance related values corresponding to nodes of the integrated circuit to use as inputs to the data model.

17. The computing system as recited in claim 15, wherein:
the first power estimation values correspond to a first portion of the integrated circuit; and
the second power estimation values are used for a second portion of the integrated circuit.

18. The computing system as recited in claim 15, wherein the first power estimation values and the second power estimation values correspond to a pre-silicon model of the integrated circuit.

19. The computing system as recited in claim 15, wherein the circuitry is further configured to:
compare output values of the data model with the second values; and
determine the data model converges, in response to an error between the output values and the second values being less than a threshold.

20. The computing system as recited in claim 16, wherein the circuitry is further configured to divide the capacitance related values into first values that correspond to the first period of time and second values that correspond to the second period of time.
